(19) United States
(12) Patent Application Publication
(10) Pub. No.: US 2025/0303796 A1
(43) Pub. Date: Oct. 2, 2025

(54) LOW HYSTERETIC BAND SUPPORT FOR VEHICLE TIRES

(71) Applicant: The Goodyear Tire & Rubber Company, Akron, OH (US)

(72) Inventors: Daniel Ray Downing, Uniontown, OH (US); Steven Amos Edwards, Akron, OH (US)

(21) Appl. No.: 18/616,317

(22) Filed: Mar. 26, 2024

(51) Int. Cl. B60C 7/20; B29D 30/02

(52) U.S. Cl. CPC B60C 7/20; B29D 30/02

(57) ABSTRACT

A tire assembly may include a tire constructed with a pair of annular bead cores axially spaced from one another and a carcass including at least one ply wrapped around the bead cores. A spring support structure is coupled to the carcass and includes at least one coiled-wire spring extending circumferentially around an axis of rotation of the tire and circumferentially compressed or tensioned to apply a radially outward force on the body portion of the carcass. The tire may be clamped onto a vehicle wheel to adjust an axial spacing of radially inner ends of the carcass and thereby impart an axial force on the carcass. The tire may or may not include an innerliner, but does not rely on a pressurized inflation fluid to maintain a shape and performance characteristics of the tire.

### FIELD OF THE INVENTION

The present disclosure relates generally to vehicle tires and, more particularly, to tires that do not necessarily rely on air pressure to carry a load of the vehicle.

### BACKGROUND OF THE INVENTION

The pneumatic tire has been the solution of choice for vehicular mobility for over a century. Characteristics that make the pneumatic tire so dominate today include efficiency at carrying loads, because all of the tire structure is involved in carrying the load, low contact pressure, resulting in lower wear on roads due to the distribution of the load of the vehicle and low stiffness, which ensures a comfortable ride in a vehicle. The pneumatic tire is generally constructed with a carcass that gives the tire its shape, strength and stability. A drawback to a pneumatic tire is that it requires a compressed fluid to maintain the carcass in a tensile state. A loss of inflation pressure may render a conventional pneumatic tire useless.

A tire designed to operate without inflation pressure may eliminate many of the problems and compromises associated with a pneumatic tire. Neither pressure maintenance nor pressure monitoring is required. Non pneumatic tires are typically defined by their load carrying efficiency. “Bottom loaders” are essentially rigid structures that carry a majority of the load in the portion of the structure below the hub. “Top loaders” are designed so that all of the structure is involved in carrying the load. Top loaders thus have a higher load carrying efficiency than bottom loaders, allowing a design that has less mass.

### SUMMARY OF THE INVENTION

The disclosure relates to a tire with a spring support structure arranged to apply a radially outward force on a body portion of the carcass. The spring support structure may include one or more pre-stressed coil springs extending circumferentially around an axis of rotation of the tire and positioned radially inward, or radially outward, of a body portion of the carcass. The springs may be maintained in an axial array by a support bed, interlacing the springs or by a cross-spring interwoven through the coil springs. The carcass of the tire may be constructed using techniques employed in the construction of pneumatic tires, with the spring support structure installed once the carcass is sufficiently complete. The spring support structure may permit other features commonly found in pneumatic tires, such as an inner liner, sidewall materials and bead apex materials, to be eliminated or reduced, which may provide a tire with relatively low rolling resistance. In some embodiments, the tire may be installed on a vehicle wheel, which adjusts a position of radially inner ends of the carcass. The adjustment applies an axial force, which further tensions the carcass.

### Definitions

The following definitions are applicable to the present invention.

“Axial” and “axially” means lines or directions that are parallel to the axis of rotation of the tire.

“Bead core” means an annular tensile member reinforcing a bead region of a tire, commonly constructed of steel wire, cords or cables.

“Bead region” means that part of the tire wrapped by the carcass and including a bead core. The bead region generally includes radially innermost ends of the carcass.

“Belt structure” means a portion of the tire disposed radially outward of a body portion of carcass and including a tread defining a radially outermost region of the tire. A belt structure may include one or more belts constructed of annular layers or plies of parallel cords, woven or unwoven, underlying the tread, and having cords inclined respect to an equatorial plane of the tire.

“Carcass” means a usually horse-shoe shaped structure disposed radially inwardly of a belt structure and generally made up of one or more plies, or layers, of rubber, which may be reinforced with fibers or filaments constructed of materials such as nylon, carbon or glass.

“Circumferential” means lines or directions extending along the perimeter of the surface of the annular tread perpendicular to the axial direction.

“Cord” means one of 1) a plurality of filaments twisted or otherwise joined together to form an elongated strip of material; 2) a single filament (monofilament) with or without a coating; or 3) a narrow strip of material with or without twist and/or coating.

“Equatorial plane (EP)” means a plane perpendicular to an axis of rotation of a tire and passing through the center of its tread.

“Inextensible” means that a given layer or reinforcement has an extensional stiffness greater than about 25 Ksi.

“Inner” means toward the inside of the tire.

“Innerliner” means the layer or layers of elastomer or other material that form the inside surface of a tubeless tire and that contain the inflating fluid within the tire.

“Lateral” means an axial direction.

“Outer” means toward the outside of the tire.

“Overlay” means a ply arranged radially outward and/or directly on top of belts in a belt structure. Such overlays are often employed for reinforcement in high-speed tires.

“Ply” means a cord-reinforced layer of rubber; or a rubber-coated parallel cords.

“Radial” and “radially” means directions radially toward or away from the axis of rotation of the tire.

“Tread” means a molded rubber component that comes into contact with the ground or road when the tire in under normal loads.

### BRIEF DESCRIPTION OF THE DRAWINGS

The invention will be described by way of example and with reference to the accompanying drawings in which:

FIG. 1A is a cross-sectional view of non-limiting example of a non-pneumatic tire including a spring support structure disposed radially inward of a body portion of a carcass in accordance with aspects of the present disclosure.

FIG. 1B is side view of the non-pneumatic tire of FIG. 1A illustrating a radially outward force provided by the spring support structure.

FIG. 2A is a cross-sectional view of a tire assembly including the non-pneumatic tire of FIG. 1A and a vehicle wheel or other clamp for tensioning a carcass of the non-pneumatic tire.

FIG. 2B is a side view of the tire assembly of FIG. 2A illustrating the tension of the carcass and road contact pressure applied to a belt structure of the non-pneumatic tire.

FIGS. 3A through 3D are cross-sectional views of alternate embodiments of non-pneumatic tires including various arrangements of a spring support structures in accordance with aspects of the present disclosure.

FIGS. 4A and 4B are a cross-sectional views of example embodiments of pneumatic tires including at least one spring support structure in accordance with aspects of the present disclosure.

FIG. 5 is a flowchart illustrating a method of manufacture for a tire assembly in accordance with aspects of the present disclosure.

### DESCRIPTION

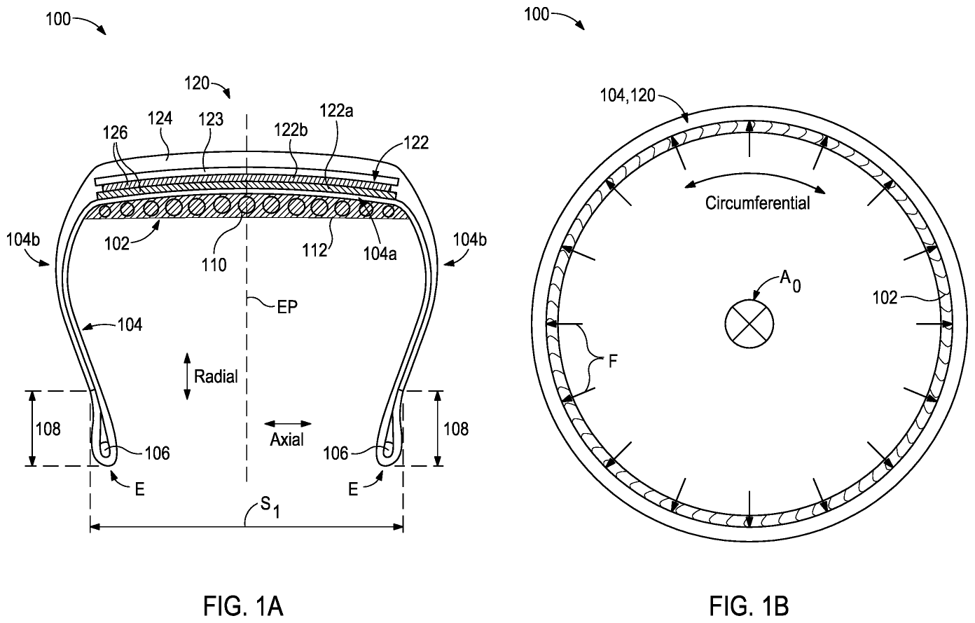

The present disclosure relates generally to tires and, more particularly, to vehicle tires that do not rely on fluid pressure to apply a tensile force to a carcass within the tire. Referring to FIG. 1A, a tire 100 is illustrated that includes a spring support structure 102 in accordance with one or more aspects of the present disclosure. The tire 100 includes a carcass 104 wrapped around axially spaced bead cores 106. The bead cores 106 are generally annular tensile members, which may be constructed of steel wire, cords or cables and reinforce a bead region 108 defined at a radially inner portion of the tire 100. The carcass 104 includes one or more plies, or layers, of rubber, which may be reinforced with fibers or filaments constructed of materials such as nylon, polyester, carbon or glass. A body portion 104a of the carcass 104 extends axially across the tire 100, and sidewall portions 104b of the carcass 104 extend radially inward from lateral edges of the body portion 104a. Radially innermost ends “E” of the sidewall portions 104b are axially separated by an initial axial spacing distance “S₀” when the tire 100 is in a non-stressed configuration.

In the embodiment illustrated in FIG. 1A, the spring support structure 102 is disposed radially inward of the body portion of the carcass 104. Also, the spring support structure 102 abuts the body portion 104a of the carcass 104 directly, but in other embodiments, one or more rubber or reinforcement layers may radially interpose the spring support structure 102 and the body portion 104a without departing from the scope of the disclosure.

The spring support structure 102 includes a plurality of springs 110 laterally spaced from one another and embedded within a support bed 112. The springs 110 extend circumferentially around an axis of rotation A₀ (FIG. 1B) of the tire 100 and may be preloaded to apply a radially outward force on the carcass 104 and other radially outer structures (e.g., belts 122 and tread portion 124), even when the tire 100 is un-deformed as described in greater detail below. The radially outward force may act similarly to compressed air in pneumatic tires.

The springs 110 may be coiled-wire springs constructed of materials such as music wire, stainless steels, high-carbon steel materials, chromium vanadium, brass, bronze, Inconel, nitinol and/or other shape memory alloys. The coiled springs 110 provide a relatively low hysteretic system for carrying operational loads of the tire 100 compared to other non-pneumatic tire constructions. The coiled springs 110 are relatively simple to fabricate, cost effective and allow for relatively low rolling resistances. In other embodiments (not shown), the springs 110 may be formed in other shapes such as flat ribbons, wavy or folded bands, or other shapes recognized in the art. The support bed 112 generally maintains the lateral spacing and distribution of the springs 110. In some embodiments, the support bed 112 may be constructed of an epoxy or other adhesive, an elastomer and/or polyurethane or another urethane material, which may be circumferentially distributed on the interior of the carcass 104 (radially inward of the body portion 104a) by spinning the carcass 104 about the axis of rotation and pouring adhesive, elastomer or urethane material into the carcass 104 in a flowable, liquid or uncured state. The springs 110 may then be embedded into support bed 112 to connect the springs 110 to the carcass 104, as well as maintaining the position of the springs 110.

Disposed radially outward of the body portion 104a of the carcass 104, the tire 100 includes a belt structure 120. The belt structure includes one or more belt layers 122a, 122b (generally or collectively belt layers 122), an optional overlay 123 and a tread portion 124 that defines a radially outermost region of the tire 100. The belt layers 122 are annular members, which may be constructed of rubber or another elastomeric material reinforced with a plurality of parallel cords 126. The parallel cords 126 may be constructed of steel wire, polyester, nylon, aramid, rayon, shape memory alloys (SMA) such as nitinol monofilaments or other materials embedded in the elastomeric coating. In some embodiments, the parallel cords 126 may be generally inextensible, e.g., the parallel cords 126 may have an extensional stiffness greater than about 25 Ksi. The parallel cords 126 in a radially inner belt layer 122a may be oriented at a first angle in a range of about 0 to about ±10 degrees, or a range of about 0 to about ±25 degrees relative to an equatorial plane EP of the non-pneumatic tire 100 (FIG. 1). Similarly, the parallel cords 126 in the outer belt layer 122b may be oriented at a second angle in the range of about 0 to about ±10 degrees, about 0 to about ±25 degrees and or about −20 to about 30 degrees relative to the equatorial plane EP. In some embodiments, the first angle and the second angle extend in opposite directions, and in other embodiments, the first and second angles extend in the same direction. In some embodiments, the parallel cords 126 in one or both of the inner and outer belt layers 122a, 122b may be substantially parallel (e.g. at an angle of about 0 degrees) with the equatorial plane EP. The parallel cords 126 may provide a sufficient tensile stiffness to the radially outer layers of the tire 100. The optional overlay 123 may be constructed of strips of elastomeric materials reinforced with parallel cords oriented at 0 degrees with respect to a longitudinal direction of the strips. The reinforced strips may be spirally wound around (radially outward of) the belt layers 122. Radially outward of the belt layers 122a, 122b, and optional overlay 123, the tread portion 124 may or may not include grooves or other patterns for contacting a road surface. The tread portion 124 may include elements such as ribs, blocks, lugs and sipes to improve a grip or other performance characteristics of the tire 100.

Referring to FIG. 1B, the spring support structure 102 extends circumferentially around the axis of rotation A₀ of the tire 100. The coiled springs 110 may be compressed in a circumferential direction such that the springs 110 provide a radially outward force “F” to the carcass 104 and the belt structure 120. The radially outward force “F_{R}” tensions the carcass 104, stiffens and tensions the belt layers 122a, 122b and tread portion 124 and is applied whether or not an inflation pressure is maintained in an interior of the tire 100.

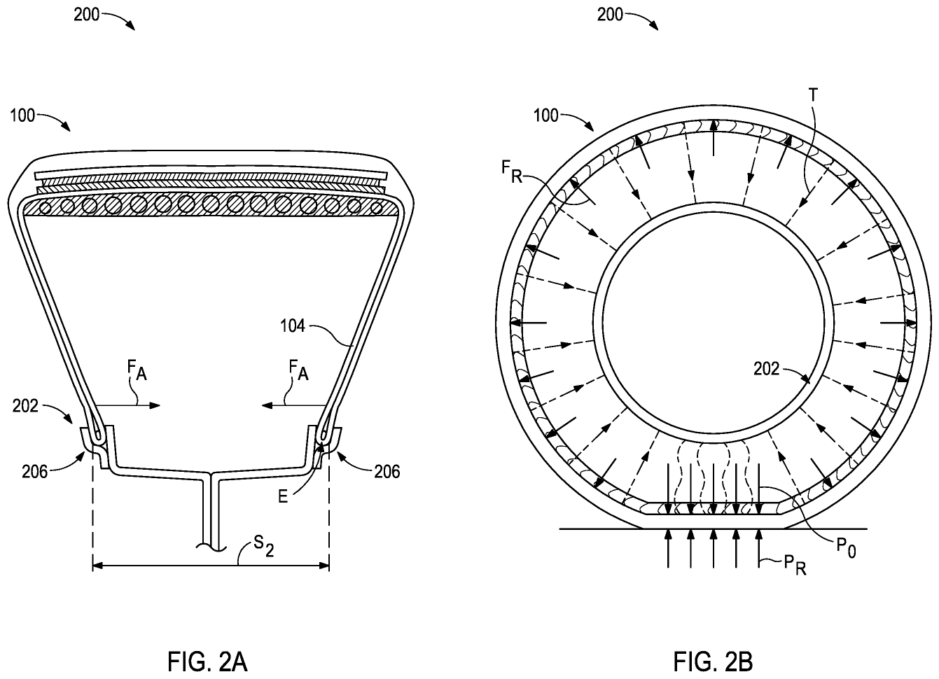

As illustrated in FIG. 2A, a tire assembly 200 includes the tire 100 and a vehicle wheel 202 or other clamp for further tensioning the carcass 104. In some embodiments, the vehicle wheel 202 a clamping split rim, on which the tire 100 is installed. The vehicle wheel 202 includes a pair of opposed grips 206, e.g., wheel rims, for restraining the radially inner ends “E” of the sidewall portions 104b of the carcass 104. The grips 206 restrain the inner ends “E” at an axial separation distance S₂ that is different than the first axial separation distance “S₁” (FIG. 1A) defined by the tire 100 in an unstressed or unrestrained state. In the illustrated embodiment, the second axial separation distance “S₂” is smaller than the first axial separation distance “S₁,” but in other embodiments, the second axial separation distance “S₂” may be greater than the first axial separation distance “S₁” without departing from the scope of the disclosure. The vehicle wheel 202 applies an axial force “F_{A}” to the tire 100 and tensions the carcass 104. Together, the axial force “F_{A}” and the radial force “F_{R}” appropriately tension the carcass 104 so that the tire 100 maintains its shape and provides the appropriate performance characteristic even in the absence of a fluid pressure within the tire 100. Among non-pneumatic tires, the construction of the tire 100 is distinctive in that it employs the traditional axial positions for the carcass 104 and bead cores 106 of pneumatic tire constructions. The axial force “F_{A}” and the radial force “F_{R}” may act similarly to compressed air in a pneumatic tire, and thus, many of the designs and techniques developed for pneumatic tires may be employed to control and optimize the performance characteristics of tire 100.

As illustrated in FIG. 2B, in operation, the tire assembly 200 opposes a road contact pressure “P_{R}” with an opposing pressure “P_{O}.” The opposing pressure “P_{O}” is provided by the stiffness in the springs 110, belts 122a, 122b and tread portion 104 in the footprint as a top-loaded tire 100. The stiffness is created by a combination of the radially outward forces “F_{R}” as well as the bending stiffness of the spring support structure 102.

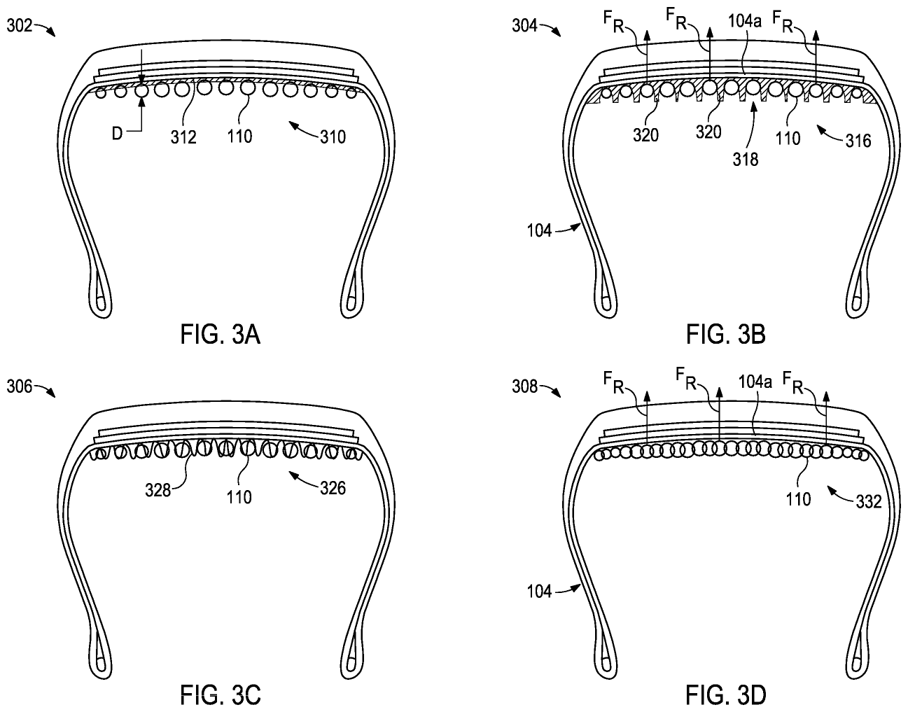

Referring now to FIGS. 3A through 3D, alternate embodiments of tires 302, 304, 306 and 308 are illustrated, which include various arrangements of a spring support structures in accordance with aspects of the present disclosure. The tire 302 (FIG. 3A) includes a spring support structure 310 in which a plurality of springs 110 are only partially embedded in a support bed 312. In some embodiments, the support bed 312 extends less than 50%, 30%, 20% or less of a diameter “D” of the coiled springs 110. Thus, the support bed 312 maintains a lateral position of each of the springs 110, while a portion of the springs 110 protruding from the support bed 312 are free to bend, compress or otherwise react to changing road conditions. The tire 302 with partially embedded springs 110 may have a reduced weight, lower rolling resistance and may generate and retain less heat than the tire 100 (FIG. 1) with fully embedded springs 110. The tire 304 (FIG. 3B) includes a spring support structure 316 in which a plurality of springs 110 are retained within circumferential grooves 318 defined in a support bed 320. The lateral position of the springs 110 may be restrained by the protruding portions 322 of the support bed 320 between the grooves 318. The radial position of the springs 100 may be restrained by the circumferential compression of the springs 110 that cause the springs 110 to impart the radially outward force F_{R} on the body portion 104a of the carcass 104 as described above. In some embodiments, the radial compression of the springs 110 alone maintains each spring within its respective groove 318, and in other embodiments, the springs 110 may be retained with an adhesive (not shown) or by partially embedding the springs 110 within the support bed 320.

The tire 306 (FIG. 3C) includes a spring support structure 326 in which a plurality of circumferentially coiled springs 110 are coupled to one another by a laterally extending cross-spring 328 interwoven among the coiled springs 110. The cross spring 328 may be constructed similarly to the coiled springs 110, or, in some embodiments, may be a straight wire interwoven among coils of the coiled springs 110. In the embodiment illustrated, the cross spring 328 extends laterally across each of the coiled springs 110 in the spring support structure 326, but in other embodiments, the cross spring 328 may extend across fewer than all of the coiled springs 110. Two or more cross springs 328 may be circumferentially spaced around the tire 306 to collectively engage each of the cross springs 110 and maintain the lateral position of each of the springs 110. The tire 308 (FIG. 3D) includes a spring support structure 322 in which each of a plurality of coiled springs 110 are interlaced with at least one laterally adjacent coiled spring 110. By joining the coiled springs 110 to one another, the lateral spacing of the coiled springs 110 may be maintained and the spring support structure may provide a uniform or other desired lateral distribution of the radially outward force “F_{R}” on the body portion 104a of the carcass 104.

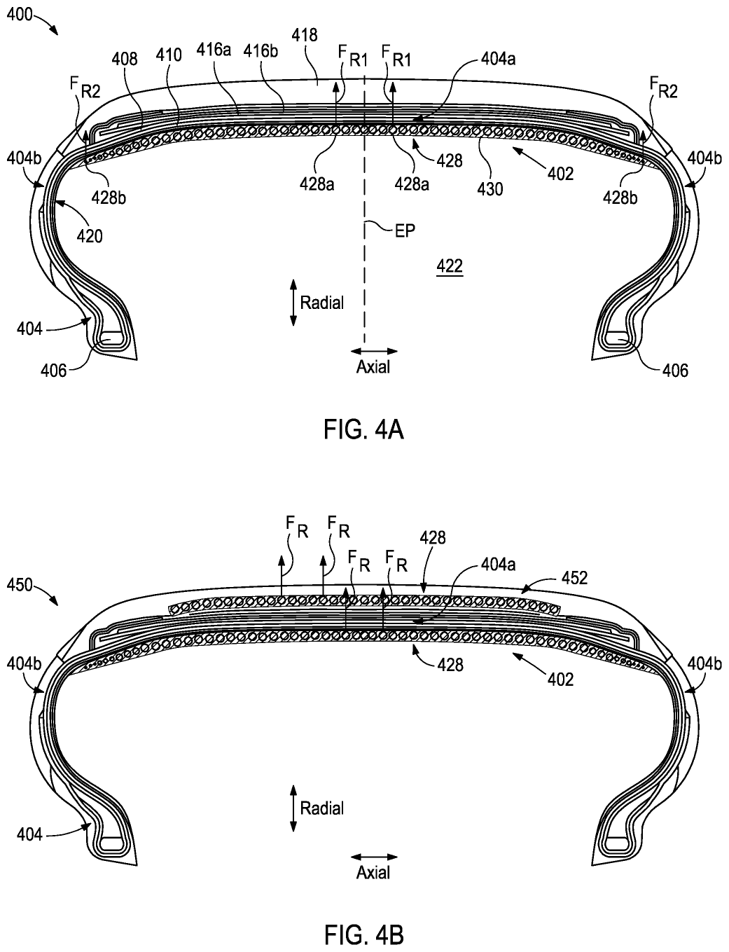

Referring to FIG. 4A, a pneumatic tire 400 including a spring support structure 402 is illustrated. The pneumatic tire 400 includes a carcass 404 wrapped around a pair of axially spaced bead cores 406. The carcass 404 defines a body portion 404a extending laterally between opposing sidewall portions 404b, which extend axially between the bead cores 406 and the body portion 404a. The carcass 404 includes first and second plies 408, 410, but in other embodiments, more or fewer plies may be provided without departing from the scope of the disclosure. The tire 400 includes a belt structure 412 disposed radially outward of the body portion 404a of the carcass 404. The belt structure 412 includes one or more belt layers 416a, 416b and a tread portion 418 that defines a radially outermost region of the tire 400. The tire 400 may also include an innerliner 420 extending axially along a radial inner side of the body portion 404a of the carcass and extending radially along axial inner sides of the sidewall portions 404b of the carcass 404. The innerliner 420 is generally one or more layers of an elastomer or other material that forms an inner surface of the tire 400 and, in cooperation with a wheel (see, e.g., vehicle wheel 202 in FIG. 2A) forms an interior region 422 in the tire 400 in which a pressurized inflation fluid may be contained.

In the illustrated embodiment, the innerliner 420 interposes the spring support structure 402 and the body portion 404a of the carcass 404. In other embodiments (not shown), the spring support structure 402 may interpose the innerliner 420 and the body portion 404a of the carcass 404 such that the innerliner 420 defines a radially innermost layer of the tire. In still other embodiments (not shown), the innerliner 420 may be eliminated, and the spring support structure 402 may be disposed in contact with a radially innermost ply, e.g., second ply 410, of the carcass 404.

The spring support structure 402 includes a plurality of coiled springs 428 embedded within a support bed 430. In other embodiments, the coiled springs 428 may be retained in any of the configurations described above for retaining the coiled springs 110 with reference to FIGS. 1A and 3A through 3D. The plurality of coiled springs 428 may include a non-uniform array of springs. For example, relatively large springs 428a may be disposed adjacent the equatorial plane “EP” of the tire 400. A size of the springs 428 may generally decrease laterally outward from the equatorial plane “EP” such that relatively small springs 428b may be disposed at lateral edges of the spring support structure 402 adjacent the sidewall portions 404b of the carcass 404. The relatively large springs 428a may exert a relatively large radially outward force “F_{R1}” to the body portion 404a of the carcass 404 while the relatively small springs 428b may exert a relatively small force “F_{R2}” to the body portion 404a of the carcass 404. In this manner, a desired lateral distribution the radially outward forces on the body portion 104a of the carcass 104 may be established by varying the size of the springs 428. In other embodiments, a desired lateral distribution the radially outward forces the on body portion 404a of the carcass 404 may be established by varying one or more of a wire thickness, coil density, material, circumferential compression, and other characteristics of the springs 428.

Referring to FIG. 4B, a pneumatic tire 450 includes a first spring support structure 402 disposed on a radially inner side of the body portion 404a of the carcass 404 as described above with reference to FIG. 4A. The pneumatic tire 450 also includes a second spring support structure 452 disposed on a radially outer side of the body portion 404a of the carcass 404. The springs 428 in the spring support structure 402 may be circumferentially compressed to impart radially outward forces on the body portion 404a of the carcass 404 while the springs 428 in the second spring support structure may be circumferentially elongated, e.g., preloaded in tension, to impart the radially outward forces on the body portion 404a of the carcass 404.

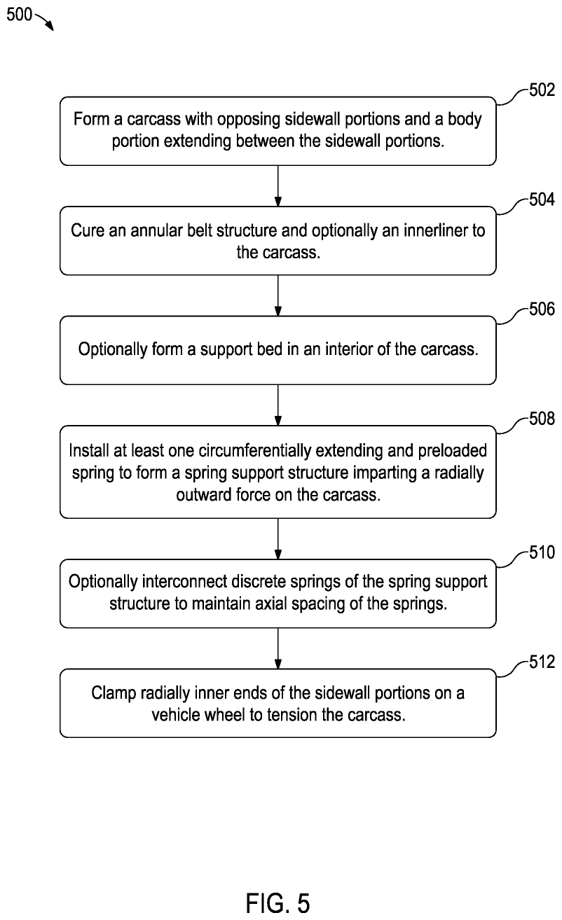

Referring to FIG. 5, a procedure 500 for manufacturing a tire assembly in accordance with aspects of the present disclosure is illustrated. Initially at step 502 a carcass is formed with opposing sidewall portions and a body portion extending laterally between the sidewall portions. At step 504, and annular belt structure may be cured to the carcass, and in some embodiments, an innerliner may be formed on an interior region of the tire. In some embodiments, a completed pneumatic or non-pneumatic tire may be provided in place of performing steps 502 and 504, and the remainder of the procedure 500 may be conducted to modify the tire. In other embodiments, the procedure 500 may be performed to create a new tire from the beginning.

At step 506, a support bed may be formed in an interior of the carcass. As described above, the support bed may be formed by pouring an adhesive or polyurethane material into the carcass in a liquid or uncured state. The carcass may be rotated about an axis of rotation of the tire to circumferentially distribute the liquid or uncured material of the support bed. In some embodiments, circumferential grooves may be formed within the support bed to receive springs therein. At step 508, a spring support structure may be installed into the carcass and/or one or more springs may be at least partially embedded within the support bed. The curable material may then be permitted to cure to thereby form the spring support structure. One or more springs, e.g., coiled wire springs, may be installed to extend to circumferentially around the axis of rotation and the springs may be preloaded to impart a radially outward force on the body portion of the carcass. In some embodiments, the springs are installed radially inward of the body portion of the carcass and are preloaded by circumferentially compressing the springs. In some embodiments, the springs are installed radially outward of the body portion of the carcass and are preloaded by circumferentially extending (tensioning) the springs. In some embodiments, the procedure 500 proceeds to step 510, where discrete springs of the spring support structure may be interconnected to maintain an axial or lateral spacing of the springs. For example, a cross spring may be interwoven within the plurality of springs or the springs may be interlaced with one or more laterally adjacent springs.

At step 512, radially inner ends of the sidewall portions may be clamped on a vehicle wheel or other clamp to adjust an axial spacing of the radially inner ends and thereby impart an axial force on the carcass. The axial force may further tension the carcass and maintain a shape of the tire. In some embodiments, an inflation fluid may be pressurized within an interior region of the tire. However, due to the radial forces applied by the spring support structure and the axial forces applied by the vehicle wheel or clamp on the carcass, the tire may not rely on the inflation fluid to maintain the desired performance characteristics. It should be appreciated that the steps of the procedure 500 may be performed out of sequence or with several steps performed simultaneously, and one or more steps of the procedure may be omitted without departing from the scope of the disclosure.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps.

Variations in the present invention are possible in light of the description herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire comprising:
first and second annular bead cores axially spaced from one another;
a carcass including at least one ply wrapped around the first and second bead cores, the carcass extending radially from the first and second bead cores to define opposing sidewall portions of the carcass and extending axially between the sidewall portions to define a body portion of the carcass; and
a spring support structure coupled to the carcass, the spring support structure including at least one spring extending circumferentially around an axis of rotation of the tire and circumferentially pre-stressed to apply a radially outward force on the body portion of the carcass.

2. The tire of claim 1, wherein the spring support structure comprises a plurality of coiled-wire springs axially spaced along a radially inner side of the body portion of the carcass and wherein the plurality of coiled wire springs are circumferentially compressed to apply the radially outward force on the body portion of the carcass.

3. The tire of claim 2, wherein the coiled-wire springs are affixed to one another by at least one of:
each of the coiled-wire springs being interlaced with at least one laterally adjacent coiled-wire spring; or
a cross-spring cross woven laterally through the plurality coiled-wire springs.

4. The tire of claim 2, wherein the spring support structure further comprises a support bed adhered to the body portion of the carcass.

5. The tire of claim 4, wherein the support bed is constructed of an epoxy, an elastomer and/or a urethane material.

6. The tire of claim 5, wherein each of the coiled-wire springs are disposed within a respective one of a plurality of axially-spaced circumferential grooves defined within the support bed such that the circumferential grooves maintain an axial separation between each of the coiled-wire springs.

7. The tire of claim 4, wherein the coiled-wire springs are partially embedded within the support bed partially protrude radially from the support bed.

8. The tire of claim 4, wherein the coiled-wire springs are fully embedded within the support bed.

9. The tire of claim 1, further comprising an innerliner interposing the spring support structure and the body portion of the carcass.

10. A tire assembly comprising:
first and second annular bead cores axially spaced from one another;
a carcass including at least one ply wrapped around the first and second bead cores, the carcass extending radially from the first and second bead cores to define opposing sidewall portions of the carcass and extending axially between the sidewall portions to define a body portion of the carcass;
an annular belt structure disposed radially outwardly of the body portion of the carcass and defining an axis of rotation of the tire, the annular belt structure including a ground-contacting tread portion at a radially outer end thereof;
a vehicle wheel secured to the carcass to define axial positions of radially inner ends of the sidewall portions and thereby apply a tensile force to the carcass; and
a spring support structure including at least one spring extending circumferentially around the axis of rotation and circumferentially stressed to apply a radially outward force on the body portion of the carcass.

11. The tire assembly of claim 10, wherein radially inner ends of the sidewall portions define a first separation distance with the carcass in an unrestrained state, and wherein the vehicle wheel includes first and second grips secured to the radially inner ends of the sidewall portions to restrain the radially inner ends at a second separation distance that is greater or less than the first separation distance.

12. The tire of claim 10, wherein the spring support structure is coupled directly to the at least one ply of the carcass on a radially inner side of the body portion of the carcass.

13. The tire of claim 10, wherein the spring support structure further comprises a support bed constructed of a flowable material having the at least one spring embedded at least partially therein.

14. The tire of claim 10, wherein the spring support structure comprises a plurality discrete wire springs axially spaced from one another along the body portion of the carcass.

15. The tire of claim 10, wherein the spring support structure comprises a plurality discrete wire springs arranged in a single row along the body portion of the carcass.

16. A method of manufacturing a tire assembly, the method comprising:
wrapping at least one ply around first and second axially spaced bead cores to form a carcass defining opposing sidewall portions and a body portion extending axially between the sidewall portions;
curing an annular belt structure to the carcass radially outwardly of the body portion of the carcass, the annular belt structure defining an axis of rotation of the tire assembly and including a ground-contacting tread portion at a radially outer end thereof;
installing a spring support structure radially inward of the body portion of the carcass, the spring support structure including at least one spring extending circumferentially around the axis of rotation and circumferentially compressed to apply a radially outward force on the body portion of the carcass.

17. The method of claim 16, further comprising clamping radially inner ends of the sidewall portions between two grips of a vehicle wheel to adjust an axial spacing between the radially inner ends of the sidewall portions and thereby apply a tensile force to the carcass.

18. The method of claim 16, wherein installing the spring support structure further comprises flowing a flowable material into an interior of the carcass while spinning the carcass about the axis of rotation, and setting the flowable material about the at least one spring.

19. The method of claim 18, wherein installing the spring support structure further comprises at least partially embedding a plurality of discrete wire springs in the flowable material to define an axial spacing between the discrete wire springs.

20. The method of claim 19, further comprising coupling the discrete wire springs to one another by either interlacing the wires springs or by cross weaving a cross-spring laterally through the discrete wire springs.
